(19) United States
(12) Patent Application Publication
(10) Pub. No.: US 2018/0091463 A1
(43) Pub. Date: Mar. 29, 2018

(54) COLLABORATION CONVERSATION NOTIFICATION

(71) Applicant: Cisco Technology, Inc., San Jose, CA (US)

(72) Inventors: Mingfeng YANG, Hefei (CN); Vasi XI, Hefei (CN); Jianbin FANG, Hefei (CN)

(21) Appl. No.: 15/279,462

(22) Filed: Sep. 29, 2016

(51) Int. Cl. H04L 12/58

(52) U.S. Cl. CPC H04L 51/24; H04L 51/26; H04L 51/14

(57) ABSTRACT

A method for providing a notification of a conversation post in a digital conversation is implemented on a computing device and includes: presenting at least one conversation post from the digital conversation on a display screen of the computing device, detecting selection of the at least one conversation post for the notification, enabling selection of at least one receiving conversation participant to receive the notification, and sending the notification to the at least one receiving conversation participant.

### FIELD OF THE INVENTION

The present invention generally relates to notification regarding posts in an ongoing digital conversation in a collaborative environment.

### BACKGROUND OF THE INVENTION

Instant messaging (IM) and collaboration applications provide real-time text communication, often called “posts” or “chats”, between two or more participants, thereby supporting a “digital conversation” between the participants over a communications network, such as, for example, the Internet. Such applications often support maintaining the continuity of an ongoing digital conversation between its participants by saving the communications as they are sent as a conversation's “history”. Some or all of the digital conversation's history may be presented or made accessible to the participants when accessing a given conversation, typically, in reverse chronological order as per the time each post was contributed to the digital conversation.

### BRIEF DESCRIPTION OF THE DRAWINGS

The present invention will be understood and appreciated more fully from the following detailed description, taken in conjunction with the drawings in which:

FIGS. 1A/B-4 are simplified pictorial illustrations of displays of an exemplary collaboration application, constructed and operative in accordance with embodiments described herein;

FIG. 5 is a block diagram of a computing device operative to run the exemplary collaboration application of FIGS. 1A/B-4; and

FIGS. 6 and 7 are flowcharts of exemplary conversation sub-window processes to be executed on the computing device of FIG. 5 within the context of the exemplary collaboration application of FIGS. 1A/B-4.

### DESCRIPTION OF EXAMPLE EMBODIMENTS

### Overview

A method for providing a notification of a conversation post in a digital conversation is implemented on a computing device and includes: presenting at least one conversation post from the digital conversation on a display screen of the computing device, detecting selection of the at least one conversation post for the notification, enabling selection of at least one receiving conversation participant to receive the notification, and sending the notification to the at least one receiving conversation participant.

A method for presenting notifications for conversation posts in a digital conversation is implemented on a computing device and includes: receiving at least an indication of at least one user-initiated notification for a conversation post in the digital conversation, presenting the at least an indication on a display screen of the computing device, receiving a selection of the at least one user-initiated notification, opening the digital conversation, and displaying at least the conversation post.

### Detailed Description of Example Embodiments

It will be appreciated that digital conversations may be asynchronous. Although conversation posts may be provided in real-time or near real-time, conversation participants may often not access or read a given conversation post until sometime later. As collaboration applications, such as, for example, Cisco Spark, may support the participation of hundreds (or even more) participants in a given group conversation, the volume of conversation posts over time may render it difficult or impractical for some of the conversation participants to read each conversation post in the group conversation. Accordingly, if a given conversation post was intended to be addressed to a specific conversation participant within the context of the group conversation, it's possible that the specific conversation participant may not actually read the given conversation post.

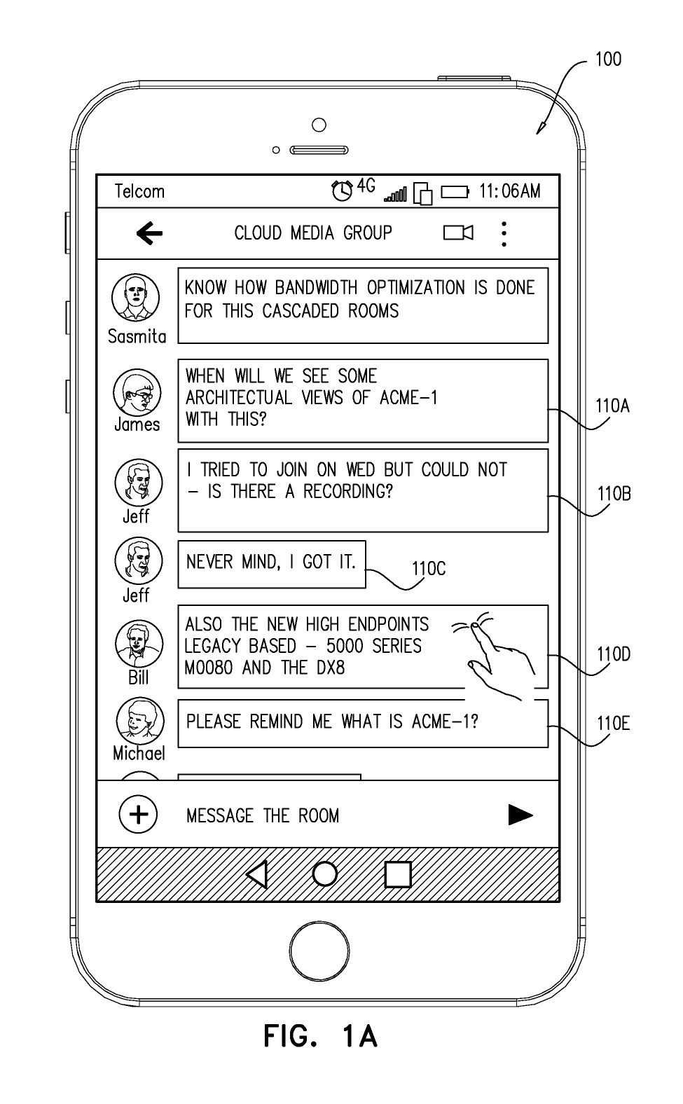

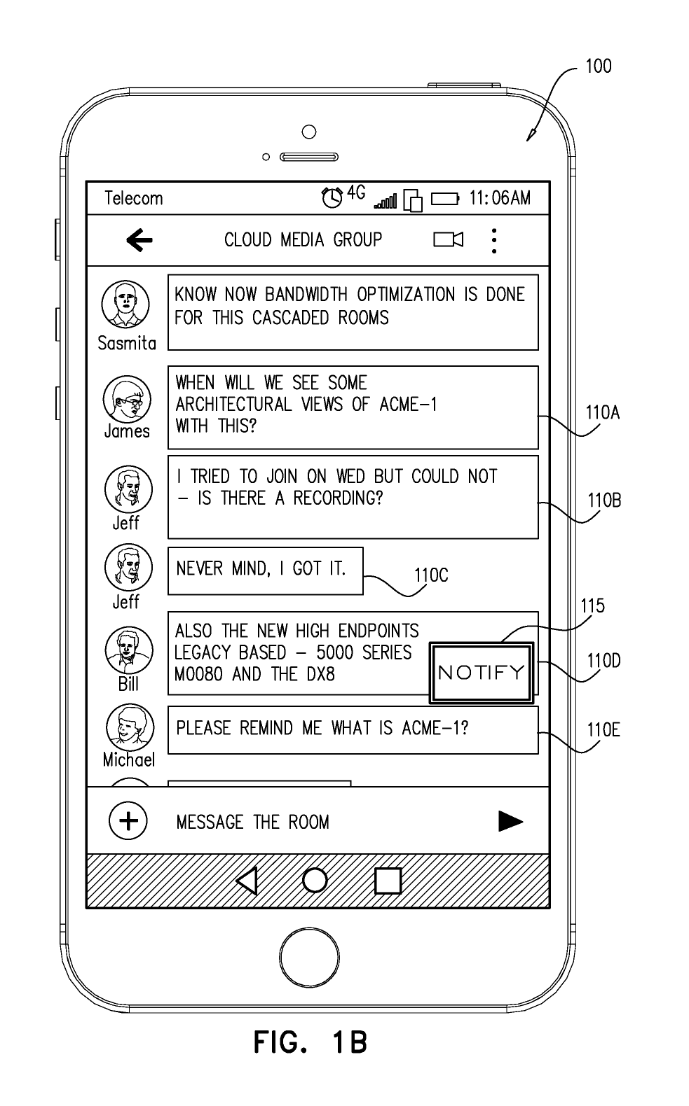

In accordance with embodiments described herein, digital conversation applications may be implemented with functionality to facilitate one conversation participant notifying one or more other conversation participants regarding a specific conversation post that may be presumed to be of interest to the conversation participant thusly notified. Reference is now made to FIG. 1A which is a simplified pictorial illustration of an exemplary digital conversation application display 100, constructed and operative in accordance with embodiments described herein. As depicted in the exemplary embodiment of FIG. 1A, display 100 is presented on a smartphone device with touchscreen functionality. It will, however, be appreciated by one of ordinary skill in the art that the embodiments described herein may support implementation on other devices (e.g., computer tablets, personal computers, etc.) and/or other user interface functionalities (e.g., mouse clicks/hovers, keyboards, etc.) as well.

Display 100 depicts an exemplary ongoing digital conversation and comprises conversation posts 110A-E, which have been contributed by participants of the digital conversation. In accordance with an exemplary embodiment described herein, the user of display 100 may wish to notify one or more of the other conversation participant about conversation post 110D, i.e., to bring conversation post 110D to the attention of one or more of the other conversation participants. To do so, the user, may select conversation post 100D. As depicted in FIG. 1A, this selection may be performed by tapping on conversation post 110D. It will, however, be appreciated that the embodiments described herein may support other means for selecting conversation posts 110. For example, depending on the configuration of the device on which display 100 is implemented, conversation posts 110 may be selected via long presses, mouse clicks, menu selection, voice commands, etc.

Reference is now made to FIG. 1B which is another simplified pictorial illustration of display 100, depicting display 100 subsequent to the selection of conversation post 110D as described with reference to FIG. 1A. Similar reference numerals refer to similar elements. Display 100 now comprises notify button 115. The user may select notify button 115 to continue the selection process initiated as per the embodiment of FIG. 1A. It will be appreciated that the use of notify button 115 is exemplary; the embodiments described herein may also support the use of a single user interface (UI) gesture for selection of conversation posts 110.

Reference is now made to FIG. 2 which illustrates an exemplary conversation participant selection window 200 that is displayed in response to selection of notify button 115 (FIG. 1B). Window 200 comprises conversation participants 210, notify checkboxes 215, notify button 220, and priority selectors 230. The user may indicate which conversation participants 210 are to be notified regarding conversation post 110D (FIGS. 1A/B) by selecting associated notify checkboxes 215. The user may also indicate a priority level (e.g., from one to five, where five is the highest priority) to be associated with the notification by selecting one of priority selectors 230. Once one or more conversation participants 210 have been indicated and one of priority selectors 230 has been selected, the user may tap or click on notify button 220 to send the notification and selected priority level to the selected conversation participants 210. It will be appreciated that window 200 may be configured with a default selection for priority.

It will be appreciated that a collaboration application such as that depicted in the exemplary embodiments of FIGS. 1A/B and 2 may typically comprise a conversation selection window operative to enable a user to select a particular conversation to display such as displayed in display 100. Reference is now made to FIG. 3A which represents an exemplary conversation selection display 301 that is displayed on a device in use by another conversation participant that receives the notification sent in the embodiment of FIG. 2. Display 301 comprises selectable conversation names 310. The user may use any suitable UI gesture (e.g., clicking, tapping, double tapping, menu selection, etc.) to select the associated conversation to view. For example, to view the IT SUPPORT GROUP conversation, the user may tap on selectable conversation name 310A; the WORLD CUP DISCUSSION GROUP conversation may be viewed by tapping on selectable conversation name 310C, etc. Upon selection, the conversation view will default to the location in the conversation associated with the notification.

Display 301 may also comprise notification indicator 320. As depicted, notification indicator 320 appears displayed next to selectable conversation name 310B (i.e., CLOUD MEDIA GROUP). In accordance with embodiments described herein, notification indicator 320 may indicate that there is a notification waiting for the user in the associated conversation (i.e., the CLOUD MEDIA GROUP conversation). As depicted, notification indicator 320 comprises a “plus-one” in a circle, thereby indicating that there is one notification for the user in the associated conversation. It will be appreciated that notification indicator 320 may comprise other numbers to indicate multiple notifications in a conversation. Similarly, display 301 may comprise more than one notification indicator 320, where each notification indicator 320 may be associated with a different conversation.

Reference is now made to FIG. 3B which represents an exemplary notification details table 302 that may be displayed on a device in use by another conversation participant that receives the notification sent in the embodiment of FIG. 2. Table 302 comprises columns of ID 330, priority 340, notifier (i.e., “from”) 350, and time 360. Alternatively, or in addition to display 301, table 302 may be displayed to present new or recent notifications to the user. ID 330 may represent an identifying serial number associated with a given notification. Priority 340 may be presented as per the selection of priority selectors 230 in FIG. 2. Notifier 350 may indicate the conversation participant that sent the notification. Time 360 may represent the time that the notification was sent. The user may select from among the notification details presented in table 302 in order to access the associated conversation, in a generally similar manner to that described with respect to the selection of a conversation with respect to the embodiment of FIG. 3A.

In accordance with some embodiments described herein, the icon representing the collaboration application may be modified to indicate to the user that one or more notifications have been received. For example, a number may be superimposed on the application icon (e.g., as presented on a desktop or home page, depending on the device), similar to notification indicator 320. In accordance with some embodiments, the priority of the associated notification(s) may be indicated by a background color or shading. For example a heat map may be defined to reflect a gradual progression from low to high priority, e.g., green may indicate low priority, whereas red may indicate high priority. It will be appreciated that depending on the implementation, other colors may be used. It will also be appreciated that background colors and/or shading may be used in a similar manner to indicate priority notification indicator 320.

Reference is now made to FIG. 4 which is a simplified pictorial illustration of an exemplary digital conversation application display 400. Display 400 depicts the exemplary conversation of display 100 as viewed on a device of a user that receives the notification. Similar to display 100 as presented in FIGS. 1A/B, display 400 also comprises conversation post 110D′ which has a notification indication (i.e., “plus-one”) to indicate that it has an associated notification.

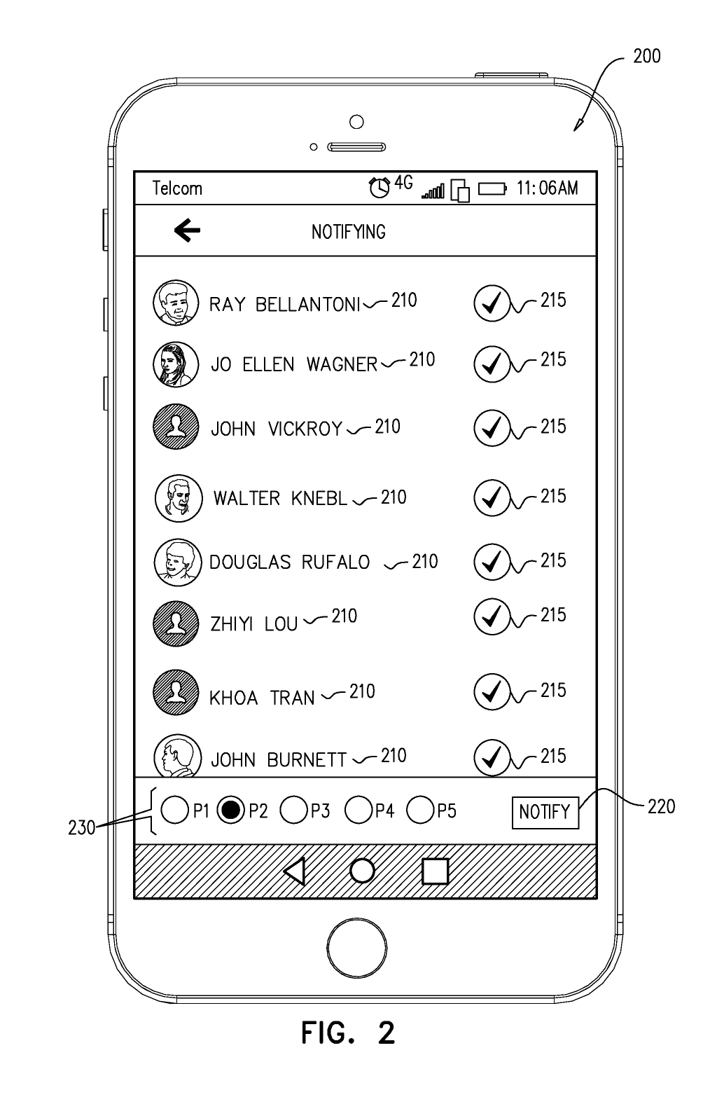

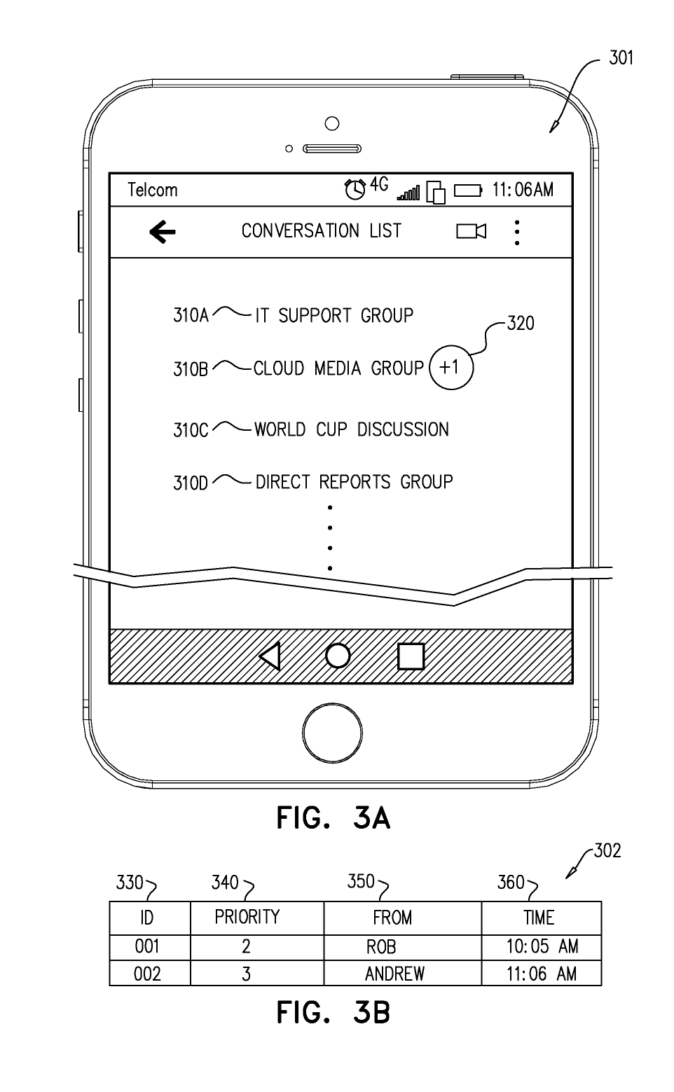

Reference is now also made to FIG. 5 which is a block diagram of a computing device 500 constructed and operative in accordance with embodiments described herein to provide an exemplary collaboration application 540 configured to present displays 100, 301, 302 and 400 as described with respect to FIGS. 1-4. Computing device 500 may be implemented as any suitable computing device such as, but not limited to, a personal computer, laptop computer, computer tablet, or smartphone that may be operative to provide the functionality described hereinabove with reference to FIGS. 1-4.

It will be appreciated by one of skill in the art that computing device 500 comprises hardware and software components that may provide at least the functionality of the embodiments described herein. For example, computing device 500 may comprise at least processor 510, I/O module 420, display screen 530, and collaboration client application 540. I/O module 520 may be implemented as a transceiver or similar means suitable for transmitting and receiving data between computing device 500 and another device. Such data may be, for example, conversation posts 110 (FIGS. 1A/B and 4) and notifications as described hereinabove. In accordance with some embodiments described herein, display screen 530 may be implemented as a touchscreen to detect the direct input of UI gestures, however, as noted hereinabove, menu selections and/or mouse clicks may also be used in addition to a touchscreen, and/or to compensate for a lack of touchscreen functionality. It will be appreciated that display screen 530 may be implemented as a built-in integrated component of computing device 500, or alternatively as an attached peripheral device.

Collaboration client application 540 may be any suitable application implemented in software and/or hardware that may be operative to facilitate a user's ongoing participation in a digital conversation as described hereinabove. For example, collaboration client application 540 may be implemented as Cisco Spark®. It will, however, be appreciated that collaboration 540 may be implemented as any suitable IM, collaboration, and/or social network application that supports ongoing digital conversations between multiple participants, such as, for example, Jabber®, WhatsApp®, or Facebook®.

It will be appreciated that computing device 500 may comprise more than one processor 510. For example, one such processor 510 may be a special purpose processor operative to execute collaboration client application 540. Collaboration client application 540 comprises notification module 545. Notification module 545 may be implemented in software and/or hardware and may be employed as necessary by collaboration client application 540 to input, modify, delete and/or present notifications for digital conversation communications transmitted/received by collaboration client application 540, typically via I/O module 520. It will be appreciated by one of ordinary skill in the art that some or all of the functionality of notification module 545 may be implemented on a collaboration server (not shown) that may be configured to facilitate collaborative communications between collaboration applications 540 on different computing devices 500. For example, the collaboration server may store some or all of the digital conversation history displayed in displays 100 and/or 400 as described hereinabove. The collaboration server may also perform indexing of the digital conversation and associated notifications in order to provide notifications and/or associated participation posts for display by collaboration client application 540 and/or notification module 545.

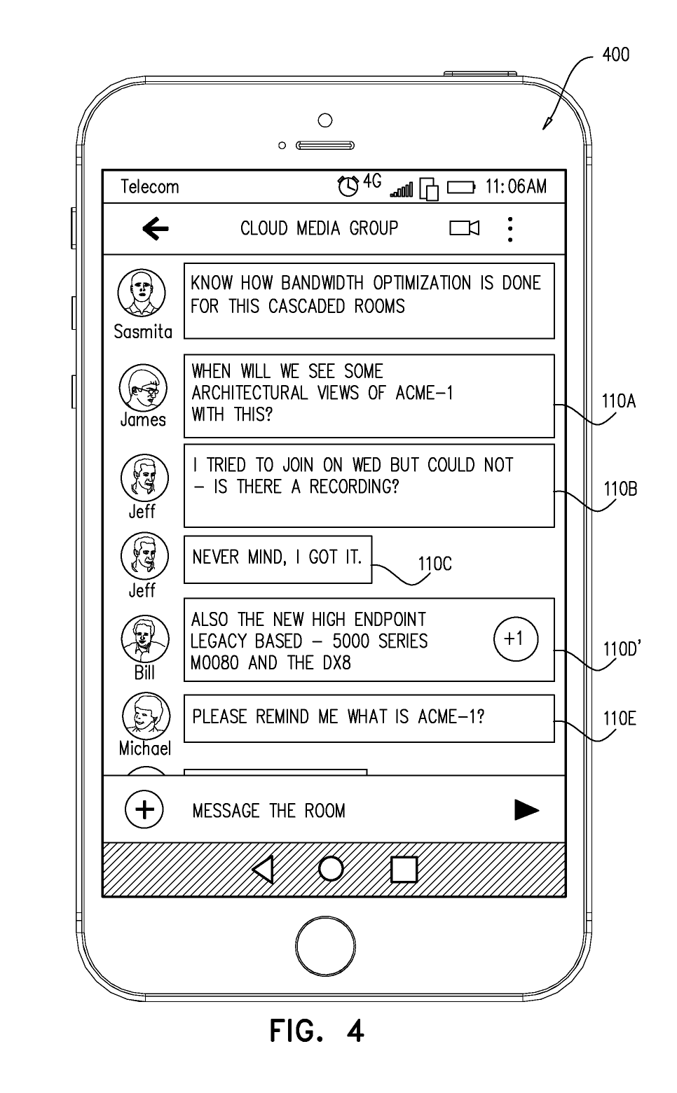

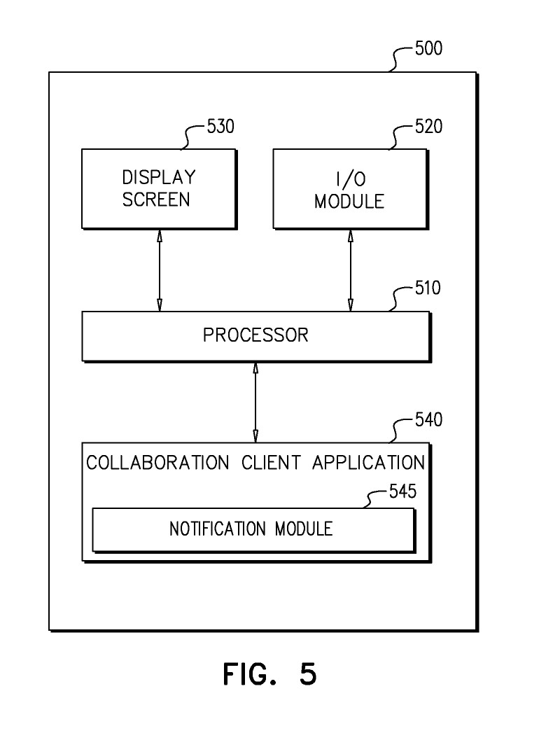

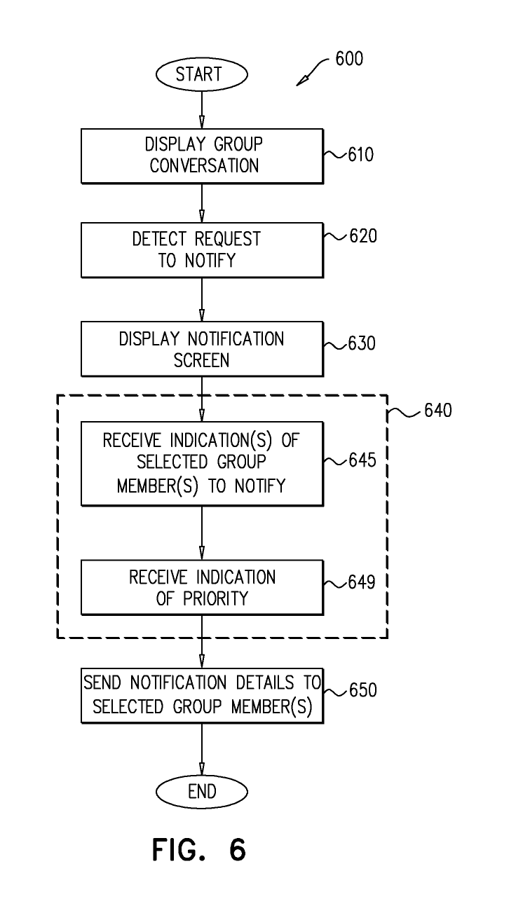

Reference is now also made to FIG. 6 which illustrates an exemplary notification process 600, constructed and operative in accordance with embodiments described herein. It will be appreciated by a person of ordinary skill in the art that collaboration client application 540 (FIG. 5) may comprise functionality as known in the art for the support of a user's ongoing participation in a digital conversation. Process 600 may be used by collaboration client application 540 and/or notification module 545 to generate and/or manage notifications for an ongoing digital conversation. Collaboration client application 540 may therefore employ notification module 545 (FIG. 5) to execute process 600 to facilitate the input of notifications within the context of the operation of corroboration client application 545.

Collaboration client application 540 displays (step 610) a group conversation with conversation posts 110 such as depicted in FIG. 1A. Notification module 545 may detect (step 620) user input indicating a request to generate a notification, e.g., a UI gesture, textual input, etc., as described with respect to FIGS. 1A/B.

In response to the detection of such user input, notification module 545 may display (step 630) conversation participant selection window 200 as per the embodiment of FIG. 2. Notification module 545 may then receive (step 640) via window 200 details for the notification to be generated. For example notification module 545 may receive (step 645) one or more indications of selected group members to notify as per the embodiment of FIG. 2, i.e., selection via notify checkboxes 215. Additionally, notification module 545 may receive (step 649) an indication of priority for the notification as per the embodiment of FIG. 2, i.e., selection via priority selectors 230.

Collaboration client application 540 may then employ I/O module 520 to send (step 650) the notification details (i.e., the selected conversation post 110, the selected group members, and/or priority) to the selected group members.

In accordance with some embodiments described herein, process 600 may be implemented to facilitate the annotation of a given notification. For example, process 600 may support user input of a text message to be provided along with the notification. Alternatively or in addition, process 600 may support recording of a voice message and/or the recording/uploading of a video clip to be provided along with the notification.

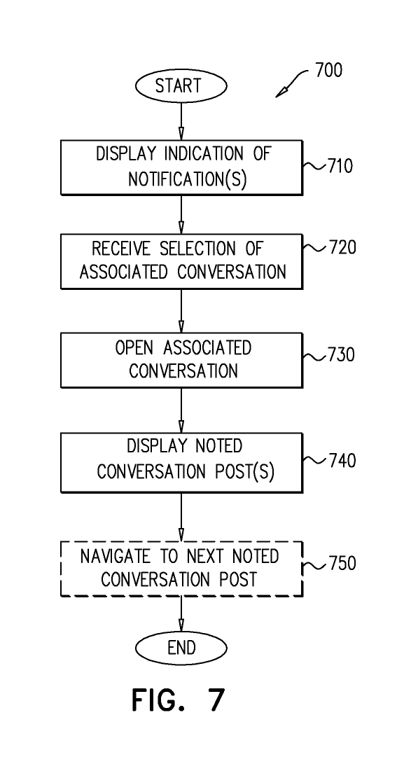

Reference is now also made to FIG. 7 which illustrates an exemplary notification presentation process 700, constructed and operative in accordance with embodiments described herein. Process 700 may be used by collaboration client application 540 (FIG. 5) and/or notification module 545 (FIG. 5) to present notifications received from one or more other computing devices 500.

Collaboration client application 540 displays (step 710) an indication of one or more notifications. For example, collaboration client application may add an indication to its associated application icon, as described hereinabove. Alternatively or in addition, an indication may be added to display 301 as per FIG. 3A. Alternatively or in addition, the indication may be displayed in table 302 as per FIG. 3B. It will be appreciated that collaboration client application 540 may receive notification details via I/O module 520 (FIG. 5) prior to the performance of process 700.

Notification module 545 may receive selection (step 720) of the associated conversation to display. Such selection may be input, for example, as a UI gesture, textual input, etc., and may be performed as described with respect to FIGS. 3A and 3B. Collaboration client application 540 may open (step 730) the associated conversation in response to the selection of step 720.

Collaboration client application 540 displays (step 740) the noted conversation post, for example, conversation post 110D′ as per the embodiment of FIG. 4. It will be appreciated that a given digital conversation may have more conversation posts 110 than may fit on a screen; accordingly collaboration client application 540 may display a section of the conversation that includes the noted conversation post, i.e., conversation post 110D′.

As discussed hereinabove, process 600 may support the provision of an annotation along with the notification. For example, a text message, voice message, and/or video clip may be provided along with the notification. It will be appreciated that process 700 may be implemented to facilitate the presentation of such an annotation to a viewing participant of the digital conversation.

It will also be appreciated that there may be more than one notification associated with a given conversation. Accordingly, collaboration client application 540 may also be operative to navigate within the conversation in order to display additional noted conversation posts. In accordance with some embodiments described herein, the user may access a table of such noted conversation posts, similar in structure to that of table 302, and select from among the noted conversation posts in the table in order to navigate within a given conversation. Furthermore, in accordance with some embodiments described herein, in the event that a conversation has multiple noted conversation posts where the priorities are not all the same, the priority indication (e.g., background color or shading) may be defined to default to indicate either the highest, lowest, or average priority.

It will be appreciated that some collaboration applications may autonomously notify conversation participants when a new conversation post is added to a digital conversation. However, the embodiments described herein support user initiated notification of specific conversation posts, even if the specific conversation posts have been previously presented to the participants of the digital conversation, i.e., the application had already sent out a new conversation post notification at some point in the past.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method for providing a notification of a conversation post in a digital conversation, the method implemented on a computing device and comprising:
presenting at least one said conversation post from said digital conversation on a display screen of said computing device;
detecting selection of said at least one conversation post for said notification;
enabling selection of at least one receiving conversation participant to receive said notification; and
sending said notification to said at least one receiving conversation participant.

2. The method according to claim 1 and wherein said enabling comprises:
displaying a list of conversation participants in a participant selection window; and
detecting said selection of at least one receiving conversation participant from among said list of conversation participants.

3. The method according to claim 1 and further comprising:
receiving an indication of priority for said notification; and
sending said indication of priority to said at least one receiving conversation participant.

4. The method according to claim 3 and further comprising:
displaying a list of priority selectors;
receiving a selection of one of said priority selectors; and
determining said indication of priority in accordance with said selection of one of said priority selectors.

5. The method according to claim 1 and further comprising:
receiving an annotation to be associated with said notification; and
sending said annotation to said at least one receiving conversation participant, wherein said annotation is at least one of a text message, a voice message, or a video clip.

6. The method according to claim 1 and wherein said at least one said conversation post was previously presented as part of said digital conversation.

7. A method for presenting notifications for conversation posts in a digital conversation, the method implemented on a computing device and comprising:
receiving at least an indication of at least one user-initiated notification for a conversation post in said digital conversation;
presenting said at least an indication on a display screen of said computing device;
receiving a selection of said at least one user-initiated notification;
opening said digital conversation; and
displaying at least said conversation post.

8. The method according to claim 7 and wherein said presenting comprises:
displaying said at least an indication as part of an application icon.

9. The method according to claim 7 and wherein said presenting comprises:
displaying said at least an indication in association with said digital conversations in a list of digital conversations.

10. The method according to claim 7 and wherein said presenting comprises:
displaying said at least an indication in a list of user-initiated notifications received on said computing device.

11. The method according to claim 7 and further comprising:
receiving an indication of priority for said at least one user-initiated notification; and
presenting said indication of priority on a display screen of said computing device.

12. The method according to claim 11 and wherein said presenting said indication of priority comprises:
displaying said indication of priority as a textual value in a list of user-initiated notifications received on said computing device.

13. The method according to claim 11 and wherein:
said presenting said at least an indication comprises displaying a background for said at least an indication; and
said presenting said indication of priority comprises: indicating said indication of priority according to a color or shade of said background.

14. The method according to claim 11 and wherein:
said receiving at least an indication comprises receiving at least an indication for at least two user-initiated notifications; and
said presenting at least an indication comprises determining an average priority for said at least two user-initiated notifications.

15. The method according to claim 11 and wherein:
said receiving at least an indication comprises receiving at least an indication for at least two user-initiated notifications in said digital conversation; and
said presenting at least an indication comprises:
determining a highest priority from among said at least two user-initiated notifications.

16. The method according to claim 7 and wherein:
said receiving at least an indication comprises receiving at least an indication for at least two user-initiated notifications; and
said displaying at least said conversation post comprises:
displaying a first conversation post associated with one of said at least two user-initiated notifications on said display screen,
receiving a user request to navigate to a second conversation post associated with another of said at least two user-initiated notifications, and
displaying said second conversation post on said display screen.

17. The method according to claim 7 and further comprising:
receiving an annotation associated with said at least one user-initiated notification; and
presenting said annotation on said computing device, wherein said annotation is at least one of a text message, a voice message, or a video clip.

18. The method according to claim 7 and wherein said at least one said conversation post was previously presented as part of said digital conversation.

19. A computing device comprising:
means for presenting at least one conversation post from a digital conversation on a display screen;
means for detecting selection of said at least one conversation post for a user-initiated notification;
means for enabling selection of at least one receiving conversation participant to receive said user initiated notification;
means for sending said notification to said at least one receiving conversation participant;
means for receiving at least an indication of at least one incoming user-initiated notification from a sending conversation participant;
means for presenting said at least an indication on said display screen;
means for receiving a selection of said at least one incoming user-initiated notification;
means for opening said digital conversation associated with said at least one incoming user-initiated notification; and
means for displaying at least said conversation post associated with said at least one incoming user-initiated notification.

20. The computing device according to claim 19 and further comprising:
means for inputting a priority for said user-initiated notification; and
means for presenting said at least one incoming user-initiated notification.
